(19) United States
(12) Patent Application Publication
(10) Pub. No.: US 2011/0307488 A1
(43) Pub. Date: Dec. 15, 2011

(54) INFORMATION PROCESSING APPARATUS, INFORMATION PROCESSING METHOD, AND PROGRAM

(75) Inventors: Norio Hirai, Tokyo (JP); Mitsunori Kori, Tokyo (JP)

(73) Assignee: MITSUBISHI ELECTRIC CORPORATION, Tokyo (JP)

(21) Appl. No.: 13/202,803

(22) PCT Filed: Feb. 27, 2009
(86) PCT No.: PCT/JP2009/053728

§ 371 Date: Aug. 23, 2011

(51) Int. Cl. G06F 17/30

(52) U.S. Cl. 707/740; 707/769; 707/E17.061; 707/E17.089

(57) ABSTRACT

A behavior index indicates a development of occurrence of events included in log data by a connection of a plurality of nodes, and includes a branching node connecting to two or more subsequent nodes and an integrating node connected to two or more preceding nodes. When a regular expression converting part inputs a search condition indicating an event appearance order from a client, a search automaton retaining part generates a state transition table in accordance with the search condition. While a node type determining part determines the node types of the respective nodes of the behavior index, a state evaluating part analyzes the respective nodes to determine the states of the respective nodes, and determines whether or not a state transition pattern matches the state transition table. Regarding a branching node, the respective nodes of each of branching routes branching from the branching node are analyzed. Regarding an integrating node, the respective nodes of each of upstream routes merging into the integrating node are analyzed.

### TECHNICAL FIELD

The present invention relates to a method in which an efficient and high-speed search is conducted by specifying an appearance pattern of events and the like based on order information included in a log.

### BACKGROUND ART

An attempt has been made in the field mainly such as information security, network surveillance, and facility management, to improve managements on information, network, and facility through monitoring the history of information leak, unauthorized access, device trouble, and the like using log data collected and accumulated.

For this purpose, the history data of the monitoring target need be collected to track how the target is behaving during a certain period of time.

Information related to an action, such as monitoring target identification ID, time stamp, and event is recorded in the history data.

However, the structure of such information is not provided with a means for managing the occurrence order, and is accordingly unsuitable to the requirements such as editing the monitoring target over a predetermined period of time.

In view of this problem, a technique is available which, e.g., in document search, converts a search condition expression which expresses an appearance pattern of character strings in a regular expression into a search automaton equivalent to it, and searches the appearance pattern for a generated state transition table.

A technique is also available which specifies and searches a subgraph in a data structure expressed by a graph structure.

A combination of the above two techniques is also available which extracts tags from an XML (Extensible Markup Language) document, being a hierarchical structure document, so that the tag appearance pattern is searched as a search automaton (see, e.g., Patent Literature 1).
Patent Literature 1: JP 2004-126933

### SUMMARY OF INVENTION

### Technical Problem

For a document structure such as an XML, the above methods are effective because such document always has a start tag and an end tag which provide a complete hierarchical structure. For the history data, however, the above methods do not function efficiently because, after the data branches, the terminal end position of the information is variable.

Furthermore, the search condition expressions themselves become complicated. It is very difficult to carry out high-speed search based on the complicated search condition expressions.

It is one of the major objects of the present invention to solve the above problems. The one of the major objects is to realize a mechanism that can analyze a development of event occurrence efficiently and comprehensively when a route branches or routes integrate in information indicating the history of the development of event occurrence by connecting a plurality of nodes.

### Solution to Problem

An information processing apparatus according to the present invention includes an information storing part that stores event history information which represents a history of a development of event occurrence by a connection of a plurality of nodes and which includes at least either one of a branching node connecting to two or more subsequent nodes and an integrating node connected to two or more preceding nodes, and

an information analyzing part that analyzes respective nodes of the event history information in accordance with a node connection order, sequentially from a former node, to identify events represented by the respective nodes; determines whether or not an analysis-target node corresponds to one of a branching node and an integrating node; if the analysis-target node is the branching node, analyzes respective nodes included in each of branching routes branching from the branching node in accordance with the connection order to identify events represented by the respective nodes; if the analysis-target node is the integrating node, analyzes respective nodes included in each of upstream routes that merge into the integrating node in accordance with the connection order to identify events represented by the respective nodes; and extracts one or more patterns of event occurrence order from the event history information.

The information processing apparatus further includes

an extraction condition input part that inputs extraction-target events and an extraction condition which indicates an appearance order of the extraction-target events.

The information analyzing part determines whether or not the pattern of event occurrence order extracted matches the appearance order of the extraction-target events indicated by the extraction condition.

The information storing part stores a plurality of pieces of event history information.

The information analyzing part extracts a pattern of event occurrence order from each event history information, and extracts event history information including the pattern of event occurrence order that matches the appearance order of the extraction-target events indicated by the extraction condition.

The information storing part stores a plurality of pieces of event history information which are classified in a plurality of categories; and further stores two or more related pieces of event history information belonging to different categories, which are associated with each other.

The information analyzing part analyzes respective nodes of event history information belonging to a specific category; if the event history information of the specific category under analysis is associated with event history information of a different category, extracts the event history information of the different category associated with the event history information of the specific category, and analyzes nodes of the event history information extracted of the different category; and extracts one or more patterns of event occurrence order based on a combination of nodes of two or more pieces of event history information belonging to two or more categories.

The information storing part stores two or more related pieces of event history information belonging to the different categories, which are associated with each other in units of nodes.

The information analyzing part analyzes the respective nodes of the event history information belonging to the specific category, and if a node under analysis is associated with a node in the event history information of the different category, extracts the node associated with the node under analysis and analyzes the node extracted.

If the event history information extracted of the different category is associated with event history information of a further different category, the information analyzing part extracts event history information of the further different category, analyzes nodes of the event history information extracted of the further different category, and extracts one or more patterns of event occurrence order based on a combination of nodes of three or more pieces of event history information belonging to three or more categories.

The information storing part stores two or more related pieces of event history information belonging to different categories, which are associated with each other in units of nodes, and

The information analyzing part analyzes nodes of the event history information extracted of the different category, and if a node under analysis is associated with a node in the event history information of the further different category, extracts the node associated with the node under analysis and analyzes the node extracted.

If the event history information includes the branching node, the information analyzing part selects an analysis-target branching route from among unanalyzed branching routes, analyzes respective nodes included in the branching route selected, in accordance with a connection order, sequentially from a former node, and after analysis of the respective nodes included in the branching route selected is ended, selects a new analysis-target branching route.

If the event history information includes the integrating node, the information analyzing part selects an analysis-target upstream route from among unanalyzed upstream routes, analyzes respective nodes included in the upstream route selected, in accordance with a connection order, sequentially from a former node, and after analysis of the respective nodes included in the upstream route selected is ended, selects a new analysis-target upstream route.

After analysis of all of the upstream routes of the integrating node is ended, the information analyzing part starts analysis of respective nodes that are subsequent to the integrating node.

As a result of analysis of all of the upstream routes of the integrating node, if it is discovered that the integrating node represents a plurality of types of events, the information analyzing part repeats analysis of the respective nodes that are subsequent to the integrating node for the number of types of events represented by the integrating node.

An information processing method includes

with a computer, acquiring event history information which represents a history of a development of event occurrence by a connection of a plurality of nodes and which includes at least either one of a branching node connecting to two or more subsequent nodes and an integrating node connected to two or more preceding nodes, from a predetermined storage device, and

with the computer, analyzing respective nodes of the event history information in accordance with a node connection order, sequentially from a former node, to identify events represented by the respective nodes; determining whether or not an analysis-target node corresponds to one of a branching node and an integrating node; if the analysis-target node is the branching node, analyzing respective nodes included in each of branching routes branching from the branching node in accordance with the connection order to identify events represented by the respective nodes; if the analysis-target node is the integrating node, analyzing respective nodes included in each of upstream routes that merge into the integrating node in accordance with the connection order to identify events represented by the respective nodes; and extracting one or more patterns of event occurrence order from the event history information.

A program causes a computer to execute

an information acquiring process of acquiring event history information which represents a history of a development of event occurrence by a connection of a plurality of nodes and which includes at least either one of a branching node connecting to two or more subsequent nodes and an integrating node connected to two or more preceding nodes, from a predetermined storage device, and

an information analyzing process of analyzing respective nodes of the event history information in accordance with a node connection order, sequentially from a former node, to identify events represented by the respective nodes; determining whether or not an analysis-target node corresponds to one of a branching node and an integrating node; if the analysis-target node is the branching node, analyzing respective nodes included in each of branching routes branching from the branching node in accordance with the connection order to identify events represented by the respective nodes; if the analysis-target node is the integrating node, analyzing respective nodes included in each of upstream routes that merge into the integrating node in accordance with the connection order to identify events represented by the respective nodes; and extracting one or more patterns of event occurrence order from the event history information.

### Advantageous Effects of Invention

According to the present invention, when a route branches or routes integrate in event history information, respective nodes included in a branching route are analyzed for respective branching routes, and respective nodes included in an upstream route are analyzed for respective upstream routes. Thus, the development of event occurrence can be analyzed efficiently and comprehensively.

### DESCRIPTION OF EMBODIMENTS

### Embodiment 1

In this and the following embodiments, a mechanism will be explained which, with a data structure in which a change of a state (behavior) caused by an occurrence of an event is managed as a data model having a graph structure, converts a search condition expression which is generated from event IDs and the appearance pattern of target IDs, into an equivalent search automaton, determines whether it is an accept state using a state transition table generated by the automaton, and determines whether it is a corresponding target, so that search based on a complicated search condition in behavior search is enabled that is conventionally difficult to perform.

A mechanism will be explained which enables efficient search, when a behavior branches, without conducting redundant search.

Furthermore, a mechanism will be explained which, if a component is incorporated in a product in a manufacturing process and accordingly if tracking needs to be performed from a different perspective, enables to manage a relation from the different perspective and to carry out tracking from the different perspective.

Embodiments of the present invention shown in the drawings will be described. Note that the present invention is not limited to the embodiments shown in the drawings. Although the embodiments of the present invention will be described by referring to several logs as examples, the present invention is applicable to the history in general.

FIG. 1 is a block diagram of a search device 100 according to this embodiment.

Note that the search device 100 is an example of an information processing apparatus.

Objects from which logs are collected are not particularly limited. Note that logs 101 collected by all devices connected to a network such as a LAN (Local Area Network) can be accumulated in a specific machine.

Although FIG. 1 shows one log 101, a plurality of logs 101 may be employed.

With the collected log 101, a behavior data generating part 102 generates a behavior index 103 having a graph structure suitable for tracking the behavior of the target, and an information storing part 117 stores the behavior index 103. For example, the information storing part 117 is a memory in the search device 100, or an external storage device.

The behavior index 103, which will be described later in detail, is information that represents the history of the development of event occurrence by a connection of a plurality of nodes. In general, the behavior index 103 includes at least either a branching node connecting to two or more subsequent nodes, or an integrating node connected to two or more preceding nodes.

A search executing user inputs a search condition expression from a client 200.

The search condition expression can be of any expression format as far as it can be uniquely converted into a regular expression. The search condition expression is a condition expression that indicates events as extraction targets (extraction-target events) and an appearance order of the events being the extraction targets. The search condition expression is an example of an extraction condition.

The input search condition expression is converted into a regular expression format by a regular expression converting part 104.

The regular expression converting part 104 is an example of an extraction condition input part.

The search condition expression converted into the regular expression format by the regular expression converting part 104 is converted into a search automaton by a search automaton retaining part 105, to generate a state transition table 106. The state transition table 106 is stored at a predetermined memory area in the search device 100.

During the search, a behavior information extracting part 107 reads data of the behavior index 103. An evaluating part 110 acquires a state transitioned by the acquired behavior, and determines whether the pattern of the event occurrence order corresponding to the search condition expression exists in the behavior index 103. The determination result is stored in a search result storing part 113.

The client 200 can utilize the search result by querying the search result storing part 113.

The respective methods used in the partial match search to be described in this and the following embodiments will be exemplified specifically by a case wherein the action pattern is searched from the action log of a person such as entering and leaving a room.

The regular expression converting part 104 converts a search condition expression, which indicates the action pattern input in a format that can be converted into a regular expression, into the regular expression format.

For example, a search condition expression for searching a person entering via a gate A and leaving via a gate B is converted into a regular expression format such as “(enter room) (gate A), *(leave room) (gate B)” which includes a meta character, and characters which express behaviors.

The search automaton retaining part 105 converts the input regular-expression search condition expression into an equivalent search automaton, to generate the state transition table 106.

The state transition table is a table that describes the transition from a state to a state, in response to an input of behavior information.

The evaluating part 110 includes a state evaluating part 111 and a relation analyzing part 112.

By referring to the generated state transition table 106, the state evaluating part 111 sequentially inputs the node information (behavior information) which is extracted from the behavior index 103 by the behavior information extracting part 107 and is output from a node type determining part 108, and acquires the states of the respective nodes.

The state evaluating part 111 responds the states of the respective nodes to the node type determining part 108.

The state evaluating part 111 also determines whether the pattern of the event occurrence order in the behavior index 103 derived from the states of the respective nodes of the behavior index 103 matches the state transition pattern of the state transition table 106 generated based on the search condition expression. If the pattern of the event occurrence order matches the state transition pattern of the state transition table 106, this indicates an accept state.

Upon acquisition of the accept state, the state evaluating part 111 stores in the search result storing part 113 a corresponding tracking target (instance) and a hit position indicating in which behavior the accept state is acquired, as information indicating that a pattern corresponding to the specified search condition expression exists in the behavior information which is currently under search.

In search of the action pattern specified by the search condition expression, if the search needs to be conducted among the person, machine, file, and the like, the relation analyzing part 112 searches while switching the scope of search.

Note that the relation analyzing part 112 will be described in detail in the fourth embodiment.

The node type determining part 108 determines whether a behavior extracted by the behavior information extracting part 107 is a branching behavior (branching node) or an integrating behavior (integrating node).

Behavior branching means a case wherein, for example, by copying a file, the content of the file is inherited, and accordingly a plurality of files having different IDs are generated.

Integrating means a case wherein, for example, materials having different IDs are mixed in a manufacturing line and the IDs are integrated into one, different ID.

In accordance with the node determination result of the node type determining part 108, when the node is an integrating node or a branching node, the integrating/branching node processing part 109 stores or reads out the behavior ID of the node or the state of the node.

Each function will be described in detail hereinafter.

For this purpose, first, the data structure of the behavior index 103, which is the search target of the search device 100, will be briefly described.

FIG. 2 shows the structure of data management of the behavior index 103 which is the search target.

A main 201 is a parental structure indicating the behavior index itself, and identifies the behavior index 103.

A class 202 indicates the category that exists in the behavior index 103, and corresponds to, e.g., the user, the location, the file, or the device.

An instance 203 indicates the substance belonging to the class 202. In the case of a user class, the instance is like a user ID that can uniquely identify an individual

A behavior 204 indicates the actual behavior of an individual instance and is, e.g., a “state after entering the room” or a “state after leaving the room”.

Each behavior 204 of the behavior index 103 will be referred to as a behavior node or simply a node hereinafter.

Arrows 205 in the behavior index 103 indicate the connecting relation between behaviors. A “state before entering the room” and a “state after entering the room” are related to each other by an event 205 “enter room”.

In this embodiment, the individual event information is stored in the structure information of a subsequent behavior node.

Each behavior node of the behavior index 103 is related to a behavior structure (FIG. 10).

The behavior structure includes information on the event of the behavior node. This will be described later in detail.

In the above example, the behavior structure of the behavior node of the “state after entering the room” indicates an event of “enter room”. In this manner, an event is derived from each behavior node.

The event represented by each behavior node is an event included in the log data of the log 101.

The history of the development of event occurrence shown in the log data of the log 101 is derived from the connecting relation of the respective nodes of the behavior index 103 and the event information indicated by the behavior structures of the respective behavior nodes.

In this manner, the behavior index 103 and the behavior structures indicate the development of event occurrence in the log data by a connection of a plurality of nodes, and correspond to event history information.

FIG. 3 shows the simplest connecting relation of the behavior index. In FIG. 3, behaviors occurring at a certain instance of a certain class are managed and are simply related to each other in the order with which they have occurred.

As shown in FIG. 3, a behavior node which has one preceding node and one subsequent node is called an ordinary node.

FIG. 4 shows a relation having a hierarchical structure.

An instance A 401 generates two instances (an instance B 402 and an instance C 403) other than the instance A 401 by way of an event 408 that follows a certain behavior 404.

This relation is called a hierarchical relation, and a behavior 404 which has two or more subsequent nodes is called a branching node.

The event 408 is called a branching event.

Routes branching from a branching node (in FIG. 4, three routes, i.e., the route where a node 405 and following nodes are connected, the route where a node 406 and following nodes are connected, and the route where a node 407 and following nodes are connected) are called branching routes.

Like FIG. 4, FIG. 5 shows a hierarchical relation, but of a case of integration.

A behavior 504 of an instance A 501 and a behavior 505 of an instance B 502 are integrated to an instance C 503 by an event 507.

Such a behavior 506 which has two or more preceding nodes is called an integrating node.

The event 507 is called an integrating event.

The routes merging into the integrating node 506 (in FIG. 5, two routes, i.e., the route from the node 504 to the node 506 and the route from the node 505 to the node 506) are called upstream routes.

FIG. 6 shows the inter-class relation.

The relation managed by the behavior index 103 is generally managed in units of instances.

When the relation has a hierarchical relation, a relation between different instances is managed.

In addition, relations are managed among classes in order to relate the person, object, device, and the like to each other.

A user A belonging to a user class 601 is related to a behavior 604 of a file I belonging to a file class 602 by an event 605 that has generated a behavior 603.

This relation enables switching of the scope of search from the user class to the file class.

Switching of the scope of search over the classes will be described in the fourth embodiment.

The structure of each data in the behavior index 103 will now be described.

FIG. 7 shows a main structure 700 of the main 201. The main structure 700 has the number of classes 701 which the behavior index manages, and a class structure pointer list 702 which is for managing pointers to the class structures.

By tracing the class structure pointer list 702, all the classes can be searched from the main structure 700.

FIG. 8 shows a class structure 800 of the class 202 in the behavior index 103.

The class structure 800 has a class ID 801 to uniquely identify the class, the number of instances managed 802 which is for managing the number of instances 203 which this class manages, and an instance structure pointer list 803 which is for managing pointers to the structures of instances belonging to this class.

By tracing the instance structure pointer list 803, all the instances belonging to this class can be searched.

FIG. 9 shows an instance structure 900 of the instance 203 in the behavior index 103.

In the instance structure 900, an instance ID 901 which uniquely identifies the instance, a pointer to class structure 902 which is for managing a pointer to a class 202 to which this instance belongs, the number of behaviors managed 903 which is for managing the number of behaviors belonging to this instance, and a behavior structure pointer list 904 which is for managing pointers to behavior structures belonging to this instance are managed.

By tracing the behavior structure pointer list 904, all the behaviors belonging to this instance can be searched.

FIG. 10 shows a behavior structure 1000 of the behavior 204 in the behavior index 103.

The behavior structure 1000 has a behavior ID 1001 which uniquely identifies a behavior, a pointer to instance structure 1002 which is for managing a pointer to an instance to which this behavior belongs, and an event ID 1003 which indicates an event that has generated this behavior and which can uniquely identify the event.

The number of immediately after behaviors 1004, an immediately after behavior ID array 1005, the number of immediately before behaviors 1006, and an immediately before behavior ID array 1007 are managed as data for managing the relation between behaviors which is necessary for tracking.

The behavior structure 1000 also has the number of related classes 1008 which is for managing the number of classes related to this behavior, and a related class ID 1009 for managing the class IDs of the related classes, as data for managing a relation among classes so as to switch the scope of search.

With this data structure, among all related behaviors, search is conducted from an arbitrary behavior to another arbitrary behavior.

The respective structures shown in FIGS. 7 to 10 are related to the behavior index 103 and stored in the information storing part 117 or another memory area.

In the search device 100 according to this embodiment, first, the regular expression converting part 104 inputs the search condition indicating the event appearance order from the client 200, and the search automaton retaining part 105 generates the state transition table 106 in accordance with the search condition expression.

The behavior information extracting part 107 extracts the behavior nodes from an analysis-target instance in the behavior index 103 in accordance with the connection order sequentially. The node type determining part 108 identifies which one of the normal node, branching node, and integrating node, the analysis-target behavior node which has been extracted by the behavior information extracting part 107 is.

The state evaluating part 111 analyzes each behavior node to determine the state of each behavior node (namely, the event represented by each behavior node), and determines whether or not the transition pattern of the state matches the state transition table 106.

While the normal node continues, the state evaluating part 111 analyzes the respective behavior nodes in accordance with the connection order of the behavior nodes.

If the node type determining part 108 identifies a branching node, the behavior information extracting part 107 extracts the nodes included in each of the branching routes that branch from the branching node, in accordance with the connection order, for respective branching routes. The state evaluating part 111 analyzes the nodes included in each branching route, and determines the state of the respective nodes, for respective branching routes.

More specifically, an integrating/branching node processing part 109 registers the information on each branching node and each branching route in a branching/integrating position storing part 114 and a branching/integrating state storing part 115, and selects an analysis-target branching route from among branching routes that have not been analyzed by the state evaluating part 111 yet. The behavior information extracting part 107 extracts the respective nodes included in the branching route selected by the integrating/branching node processing part 109 in accordance with the connection order, sequentially from a former node. After the state evaluating part 111 completes analyzing the respective nodes included in the selected branching route, the integrating/branching node processing part 109 selects a new analysis-target branching route.

If the node type determining part 108 identifies an integrating node, the behavior information extracting part 107 extracts the nodes included in each of the upstream routes that merge into the branching node in accordance with the connection order for respective upstream routes. The state evaluating part 111 analyzes the nodes included in each of the upstream routes, and determines the states of the respective nodes, for respective upstream routes.

More specifically, the integrating/branching node processing part 109 registers the information on each integrating node and each merging route in the branching/integrating position storing part 114 and the branching/integrating state storing part 115, and selects an analysis-target upstream route from among upstream routes that have not been analyzed by the state evaluating part 111 yet. The behavior information extracting part 107 extracts the respective nodes included in the upstream route selected by the integrating/branching node processing part 109 in accordance with the connection order, sequentially from a former node. After the state evaluating part 111 completes analyzing the respective nodes included in the selected upstream route, the integrating/branching node processing part 109 selects a new analysis-target upstream route.

After the analysis of all the upstream routes of the integrating node is completed, the behavior information extracting part 107 starts extracting the respective nodes subsequent to the integrating node.

In this manner, the behavior information extracting part 107, the node type determining part 108, the integrating/branching node processing part 109, and the evaluating part 110 cooperate to analyze the respective nodes included in the behavior index 103. The behavior information extracting part 107, the node type determining part 108, the integrating/branching node processing part 109, and the evaluating part 110 function as an information analyzing part.

The process for the branching node will be described in the second embodiment in detail, and the process for the integrating node will be described in the third embodiment in detail.

FIG. 11 shows an example of a search condition expression 1101, an example of a state transition chart 1102 generated based on the search condition expression, and an example of a behavior index 1103 as a search target, in the case of searching the action pattern of a person to be described in the first embodiment.

The state transition chart 1102 is information equivalent to the state transition table 106. For the sake of descriptive simplicity, description may be made hereinafter by using the state transition chart in place of a state transition table.

In the behavior index 1103, the search target class is user, and the number of users belonging to the user class is three.

As the user is not copied nor integrated, there is no branching node nor integrating node.

In this example, the user instance where the pattern of an event occurrence order that matches the search condition expression 1101 exists is only a user C.

FIG. 12 is a flowchart of the process of human action pattern search in FIG. 11.

Note that the state transition table 106 has already been generated.

In step 1201, the behavior information extracting part 107 first acquires the instance of a search-target user class from a search-target behavior index 1103.

The behavior information extracting part 107 is instructed from, e.g., the client 200, to acquire the instance of the user class, so acquires the instance of the user class in response to the instruction from the client 200.

In step 1202, the behavior information extracting part 107 extracts a behavior node being the search start point in the acquired user instance from the behavior structure pointer list 904 of the instance structure 900 (FIG. 9) of the acquired user instance.

In step 1203, the node type determining part 108 identifies the type (normal node, branching node, or integrating node) of the behavior node extracted by the behavior information extracting part 107, and inputs the information of the extracted behavior node (e.g., the event ID 1003 of the behavior structure 1000 (FIG. 10)) into the state evaluating part 111.

If the node has one immediately before node and one immediately after node, this node is identified as the regular node. If the node has two or more immediately after nodes, this node is identified as the branching node. If the node has two or more immediately before nodes, this node is identified as the integrating node.

The node type determining part 108 determines the number of immediately before nodes by referring to the field of the number of immediately before behaviors 1006 of the behavior structure 1000 (FIG. 10) of the behavior node extracted by the behavior information extracting part 107, and determines the number of immediately after nodes by referring to the field of the number of immediately after behaviors 1004.

The behavior index 1103 described in this embodiment includes only normal nodes, so the process for the branching node and the process for the integrating node will not be carried out. The process for the branching node will be described in the second embodiment, and the process for the integrating node will be described in the third embodiment.

In step 1204, the state evaluating part 111 acquires the state after the transition from the information input from the node type determining part 108.

For example, when the state evaluating part 111 inputs the event ID of the second behavior (behavior ID: 2) of a user A of the behavior index 1103 of FIG. 11 from the node type determining part 108, the state evaluating part 111 can identify an event of “enter room via door 1” from the input event ID, and determines that the state of this behavior (behavior ID: 2) to be the “state after entering the room via the door 1”.

In step 1205, the state evaluating part 111 determines whether the state acquired in step 1204 is an accept state. If the acquired state is the accept state (YES in step 1205), in step S1206, the ID of this user is stored in the memory area, and the flow proceeds to the next user search process. At this time, state transition is reset.

If the acquired state is not an accept state (NO in step 1205), in step 1207, the behavior information extracting part 107 determines whether the search for the user currently under search has been carried out until the terminal end behavior. If a next behavior exists (NO in step 1207), the flow returns to step 1202. The next behavior is acquired, and the search process continues.

In step 1207, if the search has been carried out until the terminal end behavior, in step 1208, the behavior information extracting part 107 determines whether a user who is a next search target instance exists. If no such user exists, the flow ends. If a different user exists, the state transition is reset. The flow returns to step 1201. A new user is acquired, and the search process is started.

FIG. 13 shows how the state changes over time in human action pattern search of the first embodiment of FIG. 11 in accordance with the motion of the behavior.

Characters in the nodes represent the states in the state transition chart 1102.

The state of a user A 1301 changes from the state “s” of search start state to the state “p2” upon “enter room via door 1”. Upon “log-in”, the state stays “p2”. Via “leave room via door 2”, the state changes to “p3” only in response to leave room.

The state of a user B 1302 changes from the start state “s” to the state “p2” upon “enter room via door 1”. Upon “log-in” and “log-out”, the state stays “p2”. Via “leave room via door 3”, the state changes to “p3” only in response to leave room.

The state of a user C 1303 changes from the start state “s” to the state “p2” upon “enter room via door 1”. Upon “log-in”, the state stays “p2”. Upon “leave room via door 1”, the state changes to an accept state.

Therefore, in the example of the action pattern search in FIG. 11 of the first embodiment, only the user C 1303 matches the search condition expression.

### Embodiment 2

In this embodiment, an application example to the search of the behavior index 103 having a branching node will be described. The block diagram of the search device 100 is shown in FIG. 1, as with the first embodiment.

FIG. 14 shows an example of a search condition expression 1401, an example of a state transition chart 1402, and an example of a behavior index 1403, in the case of executing an operation pattern of file to be described in the second embodiment.

The search target is a file, and the number of instances belonging to the file class is three, i.e., “file A”, “file B”, and “file C”.

The file is characteristic in that it has a branching node because it is copied by a copy event or the like. The integrating/branching node processing part 109 performs a branching process.

The search condition expression 1401 indicates searching a file that has been copied and then printed.

In the behavior index 1403 of FIG. 14, the file instance where the pattern of an event occurrence order that matches the search condition expression 1401 exists is only the file C.

FIG. 15 is a flowchart of the process of file operation pattern search in FIG. 14.

Note that the state transition table 106 has already been generated.

The search process for nodes other than a branching node is the same as that of the first embodiment, and accordingly only the process concerning the branching node will be described.

In step 1501, the node type determining part 108 refers to the number of immediately after behaviors 1004 of the behavior structure 1000 (FIG. 10) of the acquired behavior. If a behavior currently under the process has two or more immediately after behaviors, the node type determining part 108 determines that this behavior is a branching node.

If the behavior currently under the process is a branching node, in step 1502, the integrating/branching node processing part 109 stores necessary information at temporary variables of the behavior structure 1000 of the branching node. In step 1503, the integrating/branching node processing part 109 stores the pointer to this behavior information structure 1000 in a branching node stack (FIG. 17). The behavior information extracting part 107 shifts to the search process for the next behavior.

FIG. 16 shows information to be added to the temporary variables of the behavior structure when the analysis-target behavior node is a branching node.

A state 1601 stores a transition state which is a response obtained from the state evaluating part 111 when the information of the branching node is input to the state evaluating part 111.

For example, if the analysis-target behavior node is the second behavior node (behavior ID: 6) of the file B in the behavior index 1403 of FIG. 14, the integrating/branching node processing part 109 acquires a response of “state after storing the file B” from the state evaluating part 111, and stores “state after storing the file B” at the state 1601.

The number of remaining unprocessed behaviors 1602 is an item that is for managing the number of unanalyzed branching routes for which the state evaluating part 111 has not conducted node analysis.

Each time analysis of a branching route ends, the number of remaining unprocessed behaviors 1602 decrements.

A most recently processed index 1603 is an item that is for managing a branching route to be analyzed next.

More specifically, the most recently processed index 1603 specifies a behavior node to be analyzed next, based on the place in the order (what number in the order an index is) in the array of the behavior IDs indicated by the “immediately after behavior ID array 1005” in the behavior structure 1000.

For example, when the branching node has two immediately after behavior nodes, the IDs of the two behavior nodes are stored at the 0th index and 1st index of the “immediately after behavior ID array 1005”. In the case of the branching node (behavior ID: 6) of the file B of the behavior index 1403 in FIG. 14, ID: 7 is stored at the 0th index and ID: 9 is stored at the 1st index of the “immediately after behavior ID array 1005”.

When the behavior node (in the case of FIG. 14, the node of ID: 7) whose ID is stored at the 0th index of the “immediately after behavior ID array 1005” is analyzed, the value of the most recently processed index 1603 becomes “0” (0th index).

When analysis ends for the respective nodes of the branching routes chained to the behavior node whose ID is stored in the 0th index, the process returns to the branching node. At this time, by referring to the value of the most recently processed index 1603, it can be determined that the process for the behavior node of the 0th index has been ended. It can then be determined that the behavior node as the next analysis target is the behavior node (in the case of FIG. 14, the node of ID: 9) whose ID is stored at the 1st index.

The temporary variables shown in FIG. 16 are initialized when it is generated. If the process no longer returns to the branching node, the temporary variables are initialized.

FIG. 17 is a concept view of the stack.

The stack stores a pointer to the behavior structure that has been determined to be the branching node.

In this case, the pointer is stored by using a pointer list which is used widely.

Note that a function that adds a new pointer to a tail 1702, a function that extracts a pointer at a head 1701, a function that extracts a pointer at the tail, and a function that extracts a pointer by specifying its place counted from the head are prepared for the pointer list.

In the case of using the stack as a stack for branching nodes, when adding a new pointer, the new pointer is always added to the tail; when extracting a pointer, it is always extracted from the tail.

A search method of searching after returning to the branching node will now be described.

FIG. 18 is a flowchart of a process in which, after analysis for a certain branching route is ended, a different branching route is to be searched after returning to the branching node.

In step 1801, the integrating/branching node processing part 109 refers to a pointer list used as a stack, to check whether or not a pointer to a behavior structure, which is a branching node, exists. This pointer is the pointer connected in step 1503 of FIG. 15.

If a pointer to a behavior structure does not exist, the search process for the instance currently under the process ends.

If a pointer to a behavior structure exists, in step 1802, the integrating/branching node processing part 109 acquires the pointer to the behavior information, which is a branching node, from the stack.

Then, in step 1803, the integrating/branching node processing part 109 increments the most recently processed index 1603 (FIG. 16) of the temporary variables stored in the behavior structure 1000 of the behavior node which is a branching node, and acquires, as the ID of the behavior node of the next search target, an ID corresponding to the incremented index number from the immediately after behavior ID array 1005.

At this time, the integrating/branching node processing part 109 refers to the number of remaining unprocessed behaviors 1602. If an unprocessed behavior node does not exist for this branching node and no branching route to be searched exists (YES in step 1803), the temporary variables are initialized, and the pointer to this branching node is deleted from the stack (step 1809).

Then, in step 1804, the state evaluating part 111 acquires the state of the branching node. In the next step 1805, the behavior information extracting part 107 acquires the behavior structure of a behavior which is immediately after the branching node.

In step 1806, the node type determining part 108 identifies the type (normal node, branching node, or integrating node) of the behavior node extracted by the behavior information extracting part 107, and inputs the information (e.g., the event ID 1003 of the behavior structure 1000 (FIG. 10)) of the extracted behavior node into the state evaluating part 111.

In step 1807, while inputting the acquired behavior information, the state evaluating part 111 continues analyzing the respective nodes of the branching route that follows the branching node.

If the node type determining part 108 extracts the branching node, the process shown in FIG. 15 is carried out. If the node type determining part 108 extracts the integrating node, the process shown in the third embodiment is carried out.

In step 1808, if the behavior information extracting part 107 confirms that the current node is a terminal end node, in step 1801, the stack is referred to again. This search process is repeated as long as a branching node exists in the stack.

In step 1808, if the current node is not a terminal end node, the flow returns to step 1805, and the behavior information extracting part 107 extracts the common structure of the next behavior.

FIG. 19 shows the transition of the state of each behavior with reference to a file search example of FIG. 14.

An instance that corresponds to the file operation pattern specified as the search condition expression is only the file B which shows an accept state.

FIG. 20 shows an example of a behavior index 2000 having branching nodes. FIG. 21 shows a change in a branching nodes stack 2010 and a change in a next behavior ID 2011 which is recognized at the branching node, both take place when the behavior index 2000 is searched using the search condition expression 1401 specified in FIG. 14.

Note that the next behavior ID 2011 of FIG. 21 is an item provided for the descriptive purpose. The item “the next behavior ID 2011” need not be directly managed in the search device 100.

The search device 100 can obtain a content corresponding to the “next behavior ID 2011” of FIG. 21 from the information on the “the number of remaining unprocessed behaviors 1602” and the information on the “most recently processed index 1603” which are shown in FIG. 16, and the information on the “immediately after behavior ID array 1005” shown in FIG. 10.

Referring to FIGS. 20 and 21, if a branching node is identified in step 2001, a pointer to a behavior with behavior ID=1 is stored in the stack (FIG. 17).

At this time point, the next behaviors ID 2011 which are search targets with respect to this branching node are ID=2 and ID=3.

In step 2002, although next behavior ID=2 is deleted, behavior ID=3 remains. Thus, the pointer to the behavior structure of this branching node is not deleted from the stack.

When the process up to step 2002 is completed, behavior ID=1 of the branching node is acquired by referring to the stack (FIG. 17).

As the next behavior ID 2011 stored at behavior ID=1 is only ID=3, the flow proceeds to step 2003.

Then, the next behavior ID=3 is deleted. Since the next behavior ID 2011 does not exist at this time point, a pointer to the behavior structure of the branching node with behavior ID=1 is deleted from the stack.

When the process proceeds up to step 2004, a branching node is detected again. A branching node with behavior ID=4 is determined to be a branching node. A pointer to the behavior structure of the branching node with behavior ID=4 is stored in the pointer stack. As the next behavior IDs 2011 of this branching node, ID=5 and ID=7 are stored.

When the process is to proceed to step 2005, although the next behavior ID=5 of the branching node is deleted, ID=7 remains. Thus, the pointer to the common structure of this branching node is not deleted from the stack, and a search is executed.

When the process of terminal end step 2006 is ended, behavior ID=4 of the branching node is acquired by referring to the stack.

The next behavior 2011 is ID=7, so that the process proceeds to step 2007.

At this time, since the next behavior ID of behavior ID=4 does not exist, behavior ID=4 is deleted from the stack.

When the process of terminal end step 2008 is ended, the stack is referred to. At this time, no branching node exists, so that all processes are ended.

In this manner, according to this embodiment, even when a behavior index includes a branching node, the nodes of all the branching routes are extracted and are analyzed. Therefore, all the occurrence order patterns of the events included in the behavior index can be covered, and a pattern that matches the search condition expression can be extracted efficiently.

### Embodiment 3

In this embodiment, an application example to the search of the behavior index 103 having an integrating node will be described. The block diagram of the search device 100 is shown in FIG. 1, as with the first embodiment.

In the manufacturing process log, as well as branching described in the second embodiment, integration of behaviors due to of material mixing steps or the like is observed.

FIG. 22 shows a search condition expression 2101, a state transition chart 2102, and a behavior index 2103 when the manufacturing process log is taken as an example.

A behavior 2105 is an integrating node where a plurality of behaviors are integrated.

Route behaviors 2104 are head behaviors of individual tracking routes.

The material instance for which an event occurrence order pattern that matches the search condition expression 2101 specified in this example is a material B.

FIG. 23 is the flowchart of a search method for a behavior index including an integrating node.

The search process for nodes other than the integrating node is the same as those of the first and second embodiments. Accordingly, only a process concerning the integrating node will be described.

In step 2201, the node type determining part 108 determines whether or not the current node is an integrating node.

Regarding integrating node determination, a node is determined as the integrating node when the number of immediately before behaviors 1006 in the behavior structure is two or more.

If the node is the integrating node, in step 2202, the integrating/branching node processing part 109 stores the state of the integrating node at temporary variables of the behavior structure 1000 of the branching node. In step 2203, the pointer to the behavior structure, which is the integrating node, is stored in an integrating node stack. The temporary variables are as shown in FIG. 16, and the stack is as shown in FIG. 17.

In step 2204, the behavior information extracting part 107 acquires the behavior of a route which is different from the route that has been traced so far.

For example, in the behavior index 2103 of FIG. 22, assume that after the behavior of ID=5 and the behavior of ID=6 are processed in this order, the node type determining part 108 determines that the behavior 2105 of ID=9 is an integrating node. In this case, the behavior information extracting part 107 acquires the behavior 2104 of ID=7, which is a behavior of a different route.

In step 2205, the behavior information extracting part 107 performs scanning from the individual parental behaviors to the integrating node. The state evaluating part 111 acquires the states of the respective behaviors till the integrating node and the state of the integrating node. If the state of the integrating node acquired by the state evaluating part 111 is a state different from the state acquired so far, the integrating/branching node processing part 109 stores this different state at the temporary variables of the integrating node.

For example, in the behavior index 2103 of FIG. 22, assume that the process reaches the behavior of ID=9 via the behavior of ID=7 and the behavior of ID=8. If the state (the state of the second time) of the behavior of ID=9 acquired by the state evaluating part 111 is different from the behavior (the state of the first time) of ID=9 acquired via the behavior of ID=5 and the behavior of ID=6, the integrating/branching node processing part 109 stores the state of the second time at the temporary variables.

Note that the state of the first time is stored at the temporary variables in step 2202.

In step 2206, the behavior information extracting part 107 determines whether or not still another route exists. If still another route exists, search of this still another route until the integrating node is further executed. If still another route does not exist, search after the integrating node (search on nodes subsequent to the integrating node) is executed.

Search subsequent to the integrating node is performed in the following manner. The state evaluating part 111 analyzes the states of the respective nodes until the terminal end for the number of times equal to the number of states stored at the temporary variables of the integrating node, and determines whether or not the states of the respective nodes correspond to the search condition expression.

FIG. 24 shows an example of a behavior index 2300 of a manufacture log, and FIG. 25 shows a change in states stored at the temporary variables and a change in integrating node stack when the behavior index 2300 of the manufacture log is searched.

This example refers to a process of manufacturing a product using materials A, B, C, D, and E, and the search condition expression is the same as 2101 of FIG. 22.

A behavior 2301 and a behavior 2302 are integrating nodes of this behavior index.

Note that the value in each node is a behavior ID that identifies the behavior.

The integrating node 2301 is detected by executing the search along a route 2306 of the material A of FIG. 24, and the pointer to the behavior structure of the integrating node 2301 is stored in the integrating node stack.

State p0 obtained at the integrating node as the result of the search is stored at the temporary variables of the integrating node.

For the integrating node 2301, behavior ID=3 is acquired as the behavior of a different route from the route of behavior ID=1. Search is executed along a route 2307 until the integrating node, and the state p0 is acquired.

This state is the same as the state acquired by the search along the route 2306, and accordingly it is not stored at state variables.

Then, search is performed along a route 2308 subsequent to the integrating node 2301 until the next integrating node 2302.

At this time, the state stored at the temporary variables of the integrating node is only p0. Hence, the state p0 is deleted from the temporary variables of the integrating node, and behavior ID=5 which is the integrating node is deleted from the integrating node stack.

The state acquired as the result of the search along the route 2308 until the integrating node 2302 is p1. Hence, behavior ID=9 which is the integrating node 2302 is stored in the integrating stack, and simultaneously the acquired state p1 is stored at the temporary variables of the integrating node 2302.

For the integrating node 2302, a route behavior 2305 is acquired.

Then, search is performed from the behavior 2305 to the integrating node 2302 along a route 2309, and the state p2 acquired at the integrating node 2302 is stored at the temporary variables of the integrating node. A case is shown wherein the second state p2 of the integrating node 2302 is different from the first state p1.

At this time point, two states p1 and p2 are stored at the temporary variables of the integrating node 2302.

The search until the integrating node has ended. Hence, a search until the terminal end is executed along a route 2310 subsequent to the integrating node 2302.

The states stored at the state variables of the integrating node 2302 include two types, namely, p1 and state p2. Therefore, the same route 2310 need be searched twice, starting with the integrating node 2302 as the start point.

In the first search, search with the state p1 is executed, and p1 is deleted from the temporary variables.

In the second search, search from the state p2 is executed, and the state variable p2 is deleted.

As all the state variables of the integrating node 2302 are deleted, the integrating node is deleted from the stack.

By referring to the stack, if it is confirmed that no integrating node exists, the search is ended.

In this manner, according to this embodiment, even if the behavior index includes an integrating node, the nodes of all the upstream routes are extracted and the nodes are analyzed. Therefore, all the patterns of the event occurrence orders included in the behavior index can be covered, and the pattern that matches the search condition expression can be extracted efficiently.

According to this embodiment, for example, if a component is incorporated in a product in a manufacturing process and accordingly if tracking needs to be performed from a different perspective, tracking from the different perspective is enabled by managing the relation from the different perspective.

### Embodiment 4

In this embodiment, the following case will be described. Namely, a behavior index (event history information) belonging to a specific class (category) is associated with the behavior index of a different class. When the nodes of a behavior index of a certain class are under analysis, if the behavior index under analysis is associated with the behavior index of a different class, the behavior index of the different class that is associated with is extracted. The nodes of the extracted behavior index of the different class are analyzed. Based on the combinations of the nodes of two or more behavior indices that belong to two or more classes, one or more patterns of the event occurrence order are extracted, and the extracted pattern is checked against the search condition expression.

FIG. 26 shows a configuration example of the search device 100 according to this embodiment.

FIG. 26 is different from FIG. 1 in that an inter-class relation definition file 116 is added in FIG. 26.

This embodiment additionally includes the operation of the relation analyzing part 112.

If the search needs to be conducted among the person, machine, file, and the like in accordance with the action pattern specified as the search condition expression, the relation analyzing part 112 searches while switching the scope of search based on the information of the inter-class relation definition file 116.

In other words, in the first to third embodiments, the search is conducted in the same class. The fourth embodiment explains a search method employing a relation structure between different classes.

FIG. 27 shows a search condition expression 2401, a state transition chart 2402, and a behavior index 2403 according to the fourth embodiment.

In FIG. 27, the search condition expression 2401 is for searching an instance belonging to a file class in which copying, printing, and thereafter duplicating by a copy machine 1 have been done.

The behavior index 2403 has a file class 2404, a user class 2405, and a machine class 2406.

Three file instances exist in the file class 2404. Two user instances exist in the user class 2405. Two machine instances exist in the machine class 2406.

Note that numerals 1 to 24 in rectangles represent behavior IDs.

The tracking target class of the search condition expression 2401 is the file class 2404. Hence, the behavior information extracting part 107 acquires the behaviors in accordance with their occurrence order, sequentially from the start behavior of the instance belonging to the file class. The node type determining part 108 determines the node types and sequentially inputs information on the respective nodes into the state evaluating part 111.

Although copy events and print events are recorded in the behaviors of the instance of the file class, a duplication event is not recorded.

Accordingly, an instance acquired in the search within the file class does not correspond to the search condition expression 2401.

For the duplication event after the print event, the relation analyzing part 112 performs search while switching the search target class from the file class 2404 to the user class 2405 using the inter-class relation definition of the inter-class relation definition file 116.

Based on FIG. 27, a procedure of extracting information input to the state evaluating part 111 in the search using the inter-class relation will be described.

First, the client 200 defines switching of the classes being searched, in the inter-class relation definition file 116, for each search condition expression ID.

A definition example 2501 of the inter-class relation definition file 116 shown in FIG. 28 is defined in relation to the search condition expression 2401 of FIG. 27. The definition example 2501 defines that the scope of search is switched from the file class to the user class, for the print event.

The relation analyzing part 112, when detecting the print event of the behavior, if the class currently under the search is file class, switches a point of view to the user class, according to the definition example 2501. The behavior information extracting part 107 then extracts the behavior of the after-switching user class from the behavior index.

At the time of switching the scope of search by the relation analyzing part 112, the behavior structure of the file class is stored in the inter-class relation stack. When the search after switching is completed till the terminal end, the behavior at the time of the search class switch is read from the stack again, and the search is continued without switching the class.

For example, with FIG. 27, in the search of the file class 2404, when the state evaluating part 111 detects a print event 2407, the relation analyzing part 112 switches the search target class to the user class 2405 at this time point based on the definition of the inter-class relation definition file 116. The behavior information extracting part 107 extracts the behaviors of the user A instance and the behaviors of the user B instance, of the user class in accordance with the node connection order. When the behavior of ID=11 of the user A or the behavior of ID=15 of the user B is obtained, the state evaluating part 111 can connect the behavior of the user class 2405 to the behavior of the file class 2404.

If the instance structure 900 is provided with an item that manages the ID of a related instance of a different class (to be expressed as a “different-class related instance ID” hereinafter), the scope of search is switched from a specific instance to a specific instance of a different class.

For example, with the behavior index 2403 of FIG. 27, if the instance ID of the user B instance is stored at the different-class related instance ID of the instance structure of the file III instance, the scope of search is switched from the file III to the user B.

Furthermore, if the behavior structure 1000 is provided with an item that manages the ID of a related behavior of a different class (to be expressed as “different-class related behavior ID” hereinafter), the scope of search is switched from a specific behavior to a specific behavior of a different class.

For example, with the behavior index 2403 of FIG. 27, if behavior ID=15 of the user B instance is stored at different-class related behavior ID of the behavior structure of the behavior of ID=7 of the file III instance, the scope of search is switched from the behavior of ID=7 of the file III to the behavior of ID=15 of the user B, as indicated by an arrow 2408.

In the user B, the event that occurs after a behavior 15 is a duplication event. If this duplication event has been processed by the copy machine 1, the search condition expression 2401 is in an accept state.

Assume that search is performed by switching the search target class to the user class and the accept state is not obtained at the terminal end. The behavior information extracting part 107 acquires the stored behavior 8 from the inter-class relation stack. Then, search in the file class 2404 is performed again starting with 8.

At this time, behavior ID=8 is deleted from the inter-class relation stack.

This embodiment has been exemplified by a case in which two classes are switched. The number of classes that are switched is not limited, and any number of classes may be employed as far as it is defined in the inter-class relation definition file 116. Hence, the scope of search may be switched among three classes or more.

In other words, it is possible to switch the scope of search from the file class to the user class and then from the user class to the machine class.

When the class for searching is to be switched, the scope of search is vast. The scope may be narrowed with a limit as to a predetermined period of time from the switch, or as to the number of predetermined behaviors from the switch, or the like.

The contents explained in the above first to fourth embodiments will be summarized as follows.

In the first to fourth embodiments, a partial match search system has been described which searches history tracking type data managing the connecting relation of history data (log) and having a data structure for tracking the actions (events) of each target in accordance with the occurrence order, based on the event occurrence pattern.

More specifically, the partial match search system includes a node type determining part, a branching node processing part, an integrating node processing part, an evaluating/determining part, and a relation analyzing part. These parts are for storing a search condition expression formed of a motion and a target ID, performing syntax analysis, generating a state transition table based on the search condition expression which is a search automaton equivalent to the input search condition expression, acquiring the state of the node that transits next, based on the input state and the ID using the transition state table, and outputting a target ID indicating that the state transition matches the search condition expression when state acquisition of all nodes is ended.

In the partial match search system described in the first to fourth embodiments, by using the state transition table, whether a state obtained in response to an input is an accept state is determined. If the state obtained is an accept state, the ID of this node is stored in a memory area. When all the nodes are searched, the number of recognized accept states and the hit positions are returned.

In the first to fourth embodiments, the partial match search system classifies and determines the type of scanned node as follows. A node having one immediately before node and one immediately after node is a “normal node”. A node having one immediately before node and two or more immediately after nodes is a “branching node”. A node having two or more immediately before nodes and one immediately after node is an “integrating node”.

In the partial match search system described in the first to fourth embodiments, when the node type determining part determines that a node under analysis is a “branching node”, the information on all the immediately after nodes of the branching node is stored in the memory area and the state of the branching node is stored in the memory area, for the number of information on the nodes. Regarding the process subsequent to the branching node, the branching node information and the state which are stored most recently are taken out of the memory area, and the state transition is acquired based on the corresponding node.

In the partial match search system described in the first to fourth embodiments, when the node type determining part determines that a node under analysis is an “integrating node”, all the parental nodes of the integrating node are acquired. The transition states from the parental nodes to the integrating node are acquired from the state transition table, and are stored for the number of parental nodes. For respective different states, determination is performed for nodes that follow the integrating node.

In the partial match search system described in the first to fourth embodiments, the relation analyzing part reads the inter-class relation definition defined in advance. Search is performed while switching the search target class during the search.

A hardware configuration example of the search device 100 shown in each of the first to fourth embodiments will now finally be described.

FIG. 29 shows an example of the hardware resources of the search device 100 shown in each of the first to fourth embodiments.

Note that the configuration of FIG. 29 is merely an example of the hardware configuration of the search device 100. The hardware configuration of the search device 100 is not limited to that shown in FIG. 29, but can be another configuration.

Referring to FIG. 29, the search device 100 comprises a CPU 911 (also referred to as a Central Processing Unit, central processing device, processing device, computation device, microprocessor, microcomputer, or processor) that executes programs.

The CPU 911 is connected to, e.g., a ROM (Read Only Memory) 913, a RAM (Random Access Memory) 914, a communication board 915, a display device 901, a keyboard 902, a mouse 903, and a magnetic disk device 920 via a bus 912, and controls these hardware devices.

Furthermore, the CPU 911 may be connected to an FDD 904 (Flexible Disk Drive), a compact disk device 905 (CDD), a printer device 906, and a scanner device 907. In place of the magnetic disk device 920, a storage device such as an optical disk device or memory card (registered trademark) reader/writer device may be employed.

The RAM 914 is an example of a volatile memory. The storage media such as the ROM 913, FDD 904, CDD 905, and magnetic disk device 920 are examples of a nonvolatile memory. These devices are examples of the storage device.

The communication board 915, keyboard 902, mouse 903, scanner device 907, FDD 904, and the like are examples of an input device.

The communication board 915, display device 901, printer device 906, and the like are examples of an output device.

The communication board 915 is connected to a network. For example, the communication board 915 may be connected to a LAN (Local Area Network), the Internet, a WAN (Wide Area Network), or a SAN (Storage Area Network).

The magnetic disk device 920 stores an operating system 921 (OS), a window system 922, programs 923, and files 924.

The CPU 911 executes each program of the programs 923 by utilizing the operating system 921 and the window system 922.

The RAM 914 temporarily stores at least some programs of the operating system 921 and some programs that are executed by the CPU 911.

The RAM 914 also stores various types of data necessary for the process performed by the CPU 911.

The ROM 913 stores the BIOS (Basic Input Output System) program. The magnetic disk device 920 stores the boot program.

When the search device 100 is booted, the BIOS program of the ROM 913 and the boot program of the magnetic disk device 920 are executed, and the BIOS program and boot program boot the operating system 921.

The programs 923 include a program that executes the function described as a “part” described in the first to fourth embodiments. The program is read and executed by the CPU 911.

The files 924 store information, data, signal values, variable values, and parameters indicating the results of the processes described as “analyzing”, “determining”, “identifying”, “comparing”, “evaluating”, “extracting”, “updating”, “setting”, “registering”, “selecting”, and the like in the description of the first to fourth embodiments, as the items of “files” and “databases”.

The “files” and “databases” are stored in a recording medium such as a disk or memory. The information, data, signal values, variable values, and parameters stored in the storage medium such as the disk or memory are read out to the main memory or cache memory by the CPU 911 through a read/write circuit, and are used for the operations of the CPU such as extraction, search, look-up, comparison, computation, calculation, process, edit, output, print, and display.

During the operations of the CPU including extraction, search, look-up, comparison, computation, calculation, process, edit, output, print, and display, the information, data, signal values, variable values, and parameters are temporarily stored in the main memory, register, cache memory, buffer memory, or the like.

The arrows of the flowcharts described in the first to fourth embodiments mainly indicate input/output of data and signals. The data and signal values are stored in a recording medium such as the memory of the RAM 914, the flexible disk of the FDD 904, the compact disk of the CDD 905, or the magnetic disk of the magnetic disk device 920; or an optical disk, mini disk, or DVD. The data and signals are transmitted online via the bus 912, signal lines, cables, and other transmission media.

The “part” in the first to fourth embodiments may be a “circuit”, “unit”, or “device”; or a “step”, “procedure”, or “process”. Namely, the “part” may be realized as the firmware stored in the ROM 913. Alternatively, the “part” may be practiced by only software; by only hardware such as an element, a device, a substrate, or a wiring line; by a combination of software and hardware; or furthermore by a combination of software, hardware, and firmware. The firmware and software are stored, as programs, in a recording medium such as a magnetic disk, flexible disk, optical disk, compact disk, mini disk, or DVD. The program is read by the CPU 911 and executed by the CPU 911. In other words, a program causes the computer to function as a “part” in the first to fourth embodiments. Alternatively, the program causes the computer to execute the procedure and method of the “part” in the first to fourth embodiments.

In this manner, the search device 100 shown in the first to fourth embodiments is a computer comprising a CPU being a processing device; a memory, magnetic disk, or the like being a storage device; a keyboard, mouse, communication board, or the like being an input device; and a display device, communication board, or the like being an output device, and realizes the functions indicated as the “parts” by using these processing device, storage device, input device, and output device, as described above.

### BRIEF DESCRIPTION OF DRAWINGS

FIG. 1 shows a configuration example of a search device according to the first embodiment.

FIG. 2 shows an example of a data structure according to the first embodiment.

FIG. 3 shows an order relation structure according to the first embodiment.

FIG. 4 shows a hierarchical relation structure according to the first embodiment.

FIG. 5 shows a hierarchical relation structure according to the first embodiment.

FIG. 6 shows an inter-class relation structure according to the first embodiment.

FIG. 7 shows a behavior index main structure according to the first embodiment.

FIG. 8 shows a class structure according to the first embodiment.

FIG. 9 shows an instance structure according to the first embodiment.

FIG. 10 shows a behavior structure according to the first embodiment.

FIG. 11 shows a search automaton and a behavior index according to the first embodiment.

FIG. 12 is a process flowchart of the first embodiment.

FIG. 13 is a state transition chart of the first embodiment.

FIG. 14 shows a search automaton and a behavior index according to the second embodiment.

FIG. 15 is a branching node process flowchart according to the second embodiment.

FIG. 16 shows branching node state management variables according to the second embodiment.

FIG. 17 shows a branching node stack according to the second embodiment.

FIG. 18 is a flowchart of a process subsequent to a branching node according to the second embodiment.

FIG. 19 is a state transition chart according to the second embodiment.

FIG. 20 shows a behavior index including branching nodes according to the second embodiment.

FIG. 21 is a table showing changes in stack and in state management variables according to the second embodiment.

FIG. 22 shows a search automaton and a behavior index according to the third embodiment.

FIG. 23 is an integrating node process flowchart according to the third embodiment.

FIG. 24 shows a behavior index including integrating nodes according to the third embodiment.

FIG. 25 is a table showing changes in stack and in state management variables according to the third embodiment.

FIG. 26 shows a configuration example of a search device according to the fourth embodiment.

FIG. 27 shows a search automaton and a behavior index according to the fourth embodiment.

FIG. 28 shows a definition file of search target class switching according to the fourth embodiment.

FIG. 29 shows a hardware configuration example of a search device according to the first to fourth embodiments.

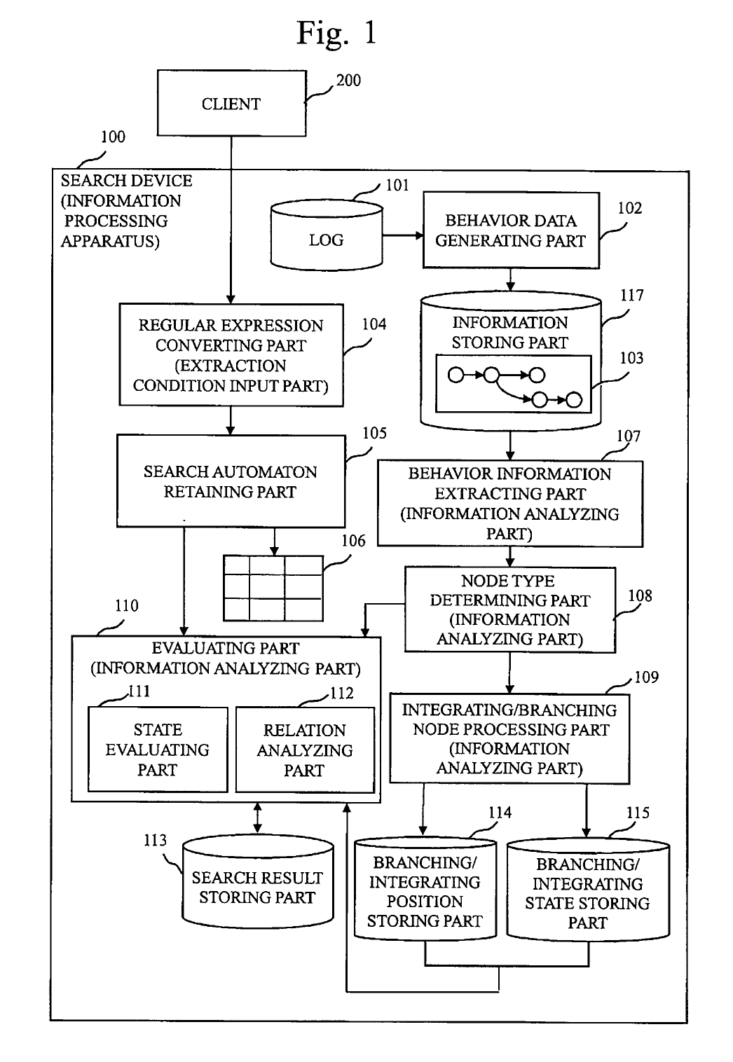

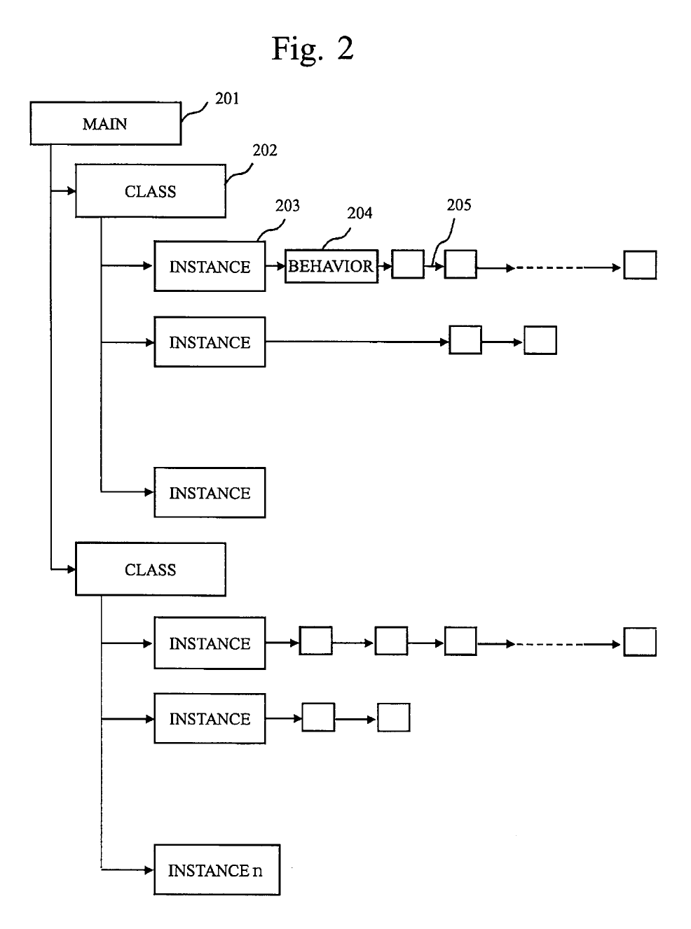

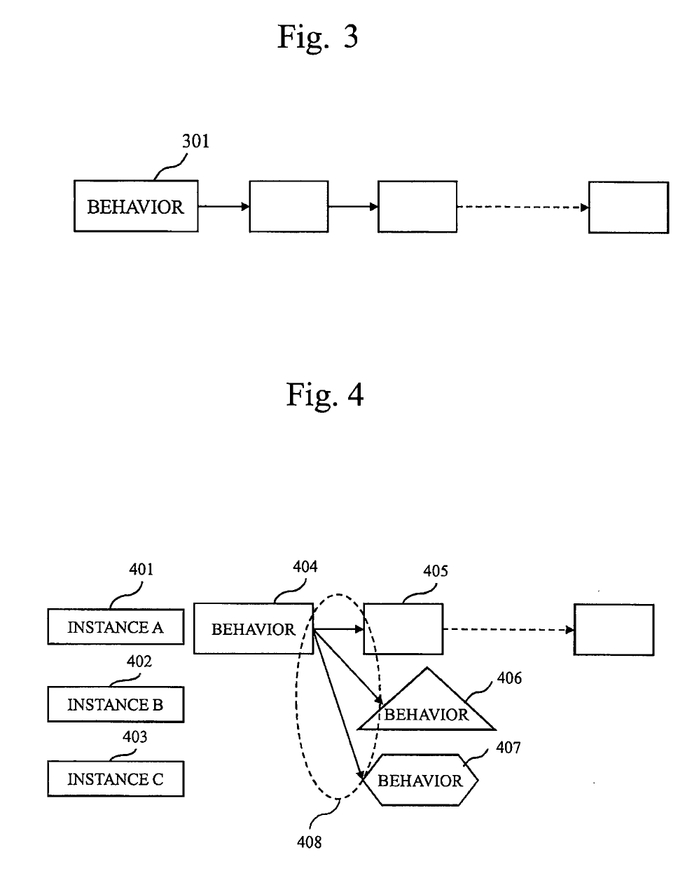

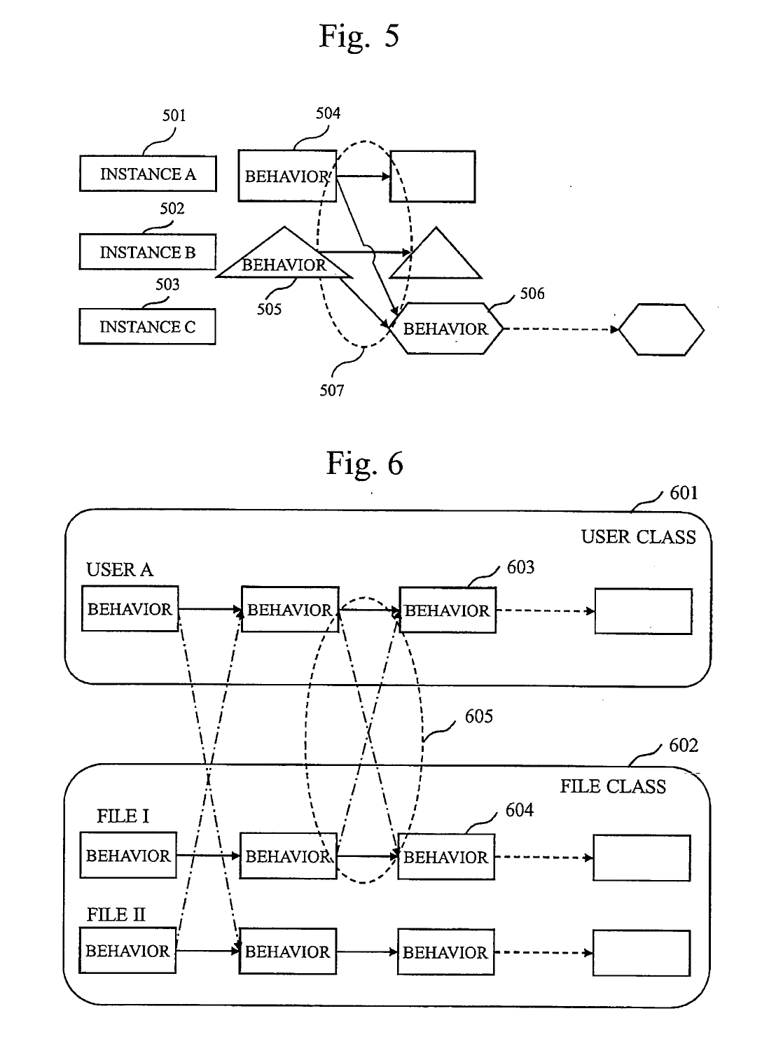

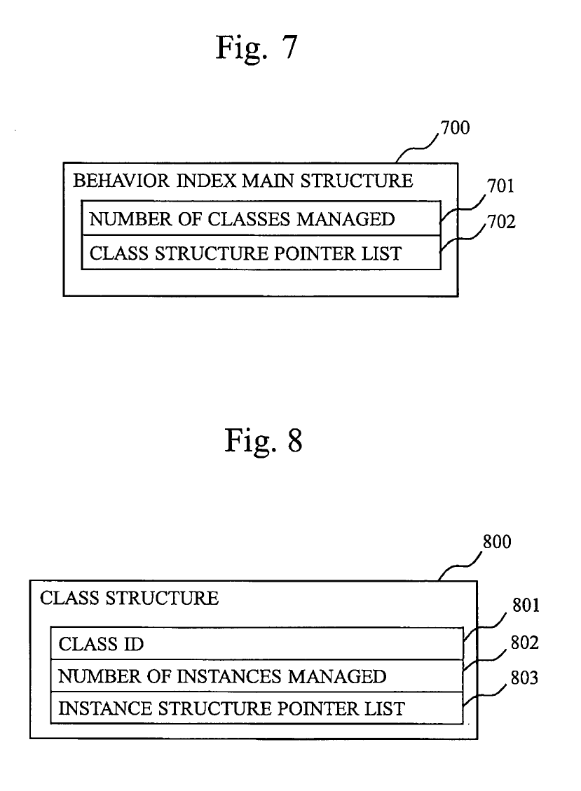

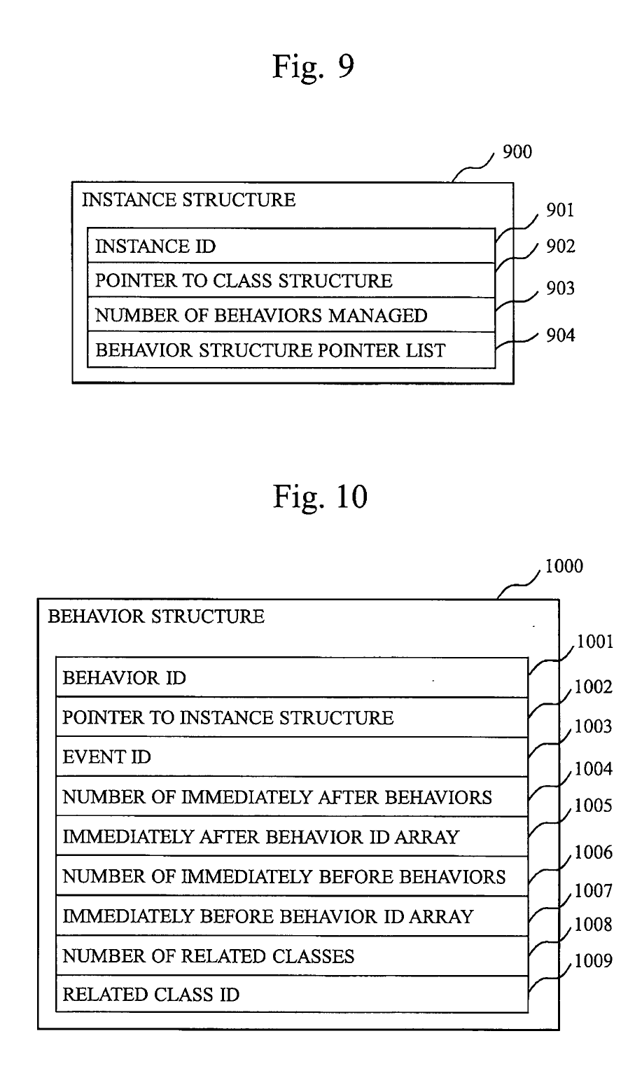

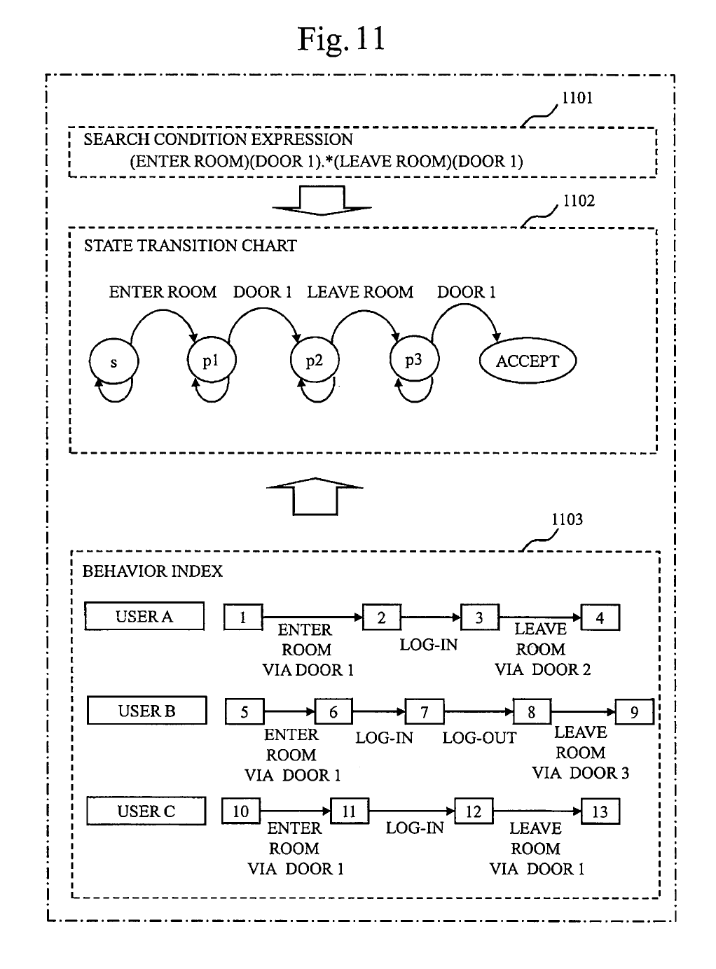

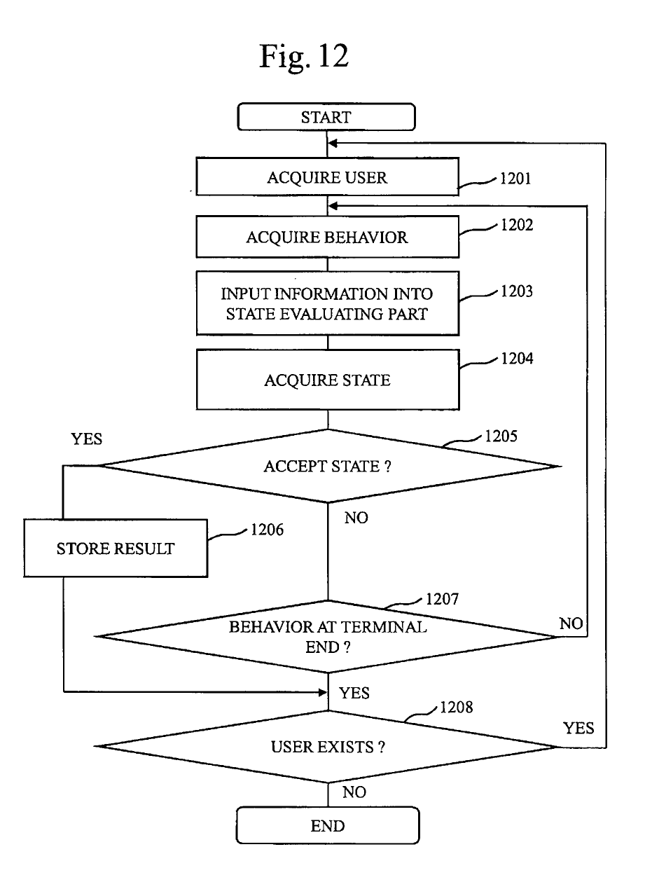

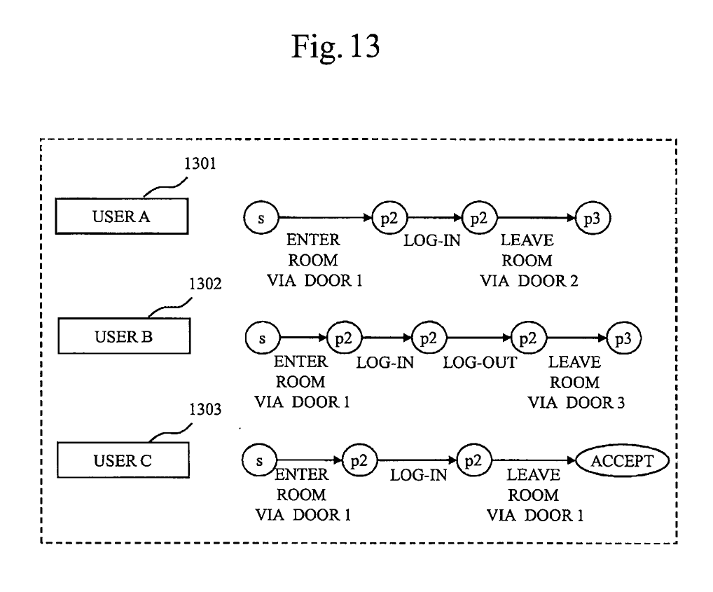

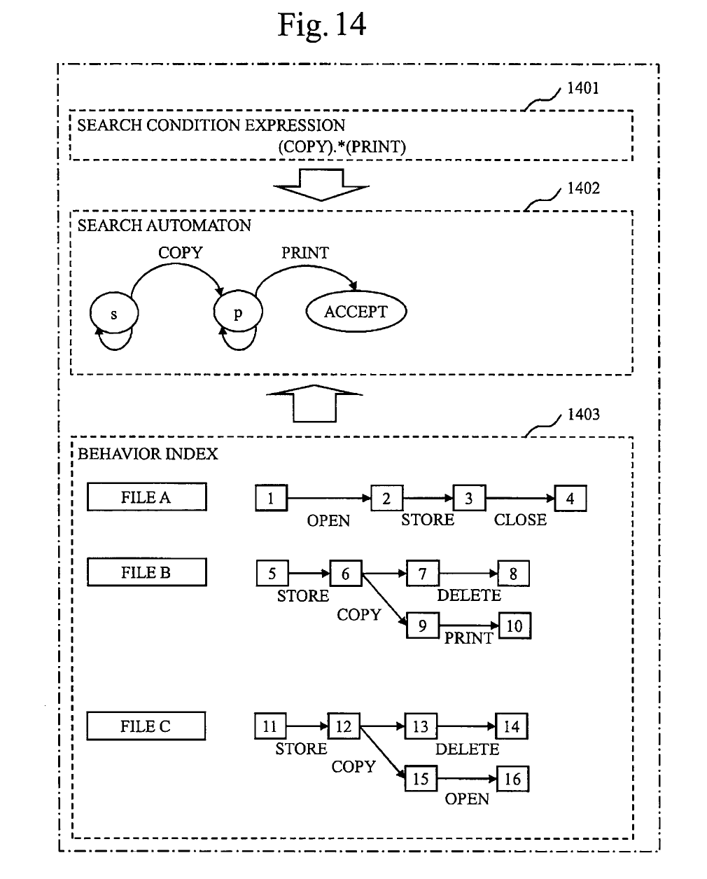

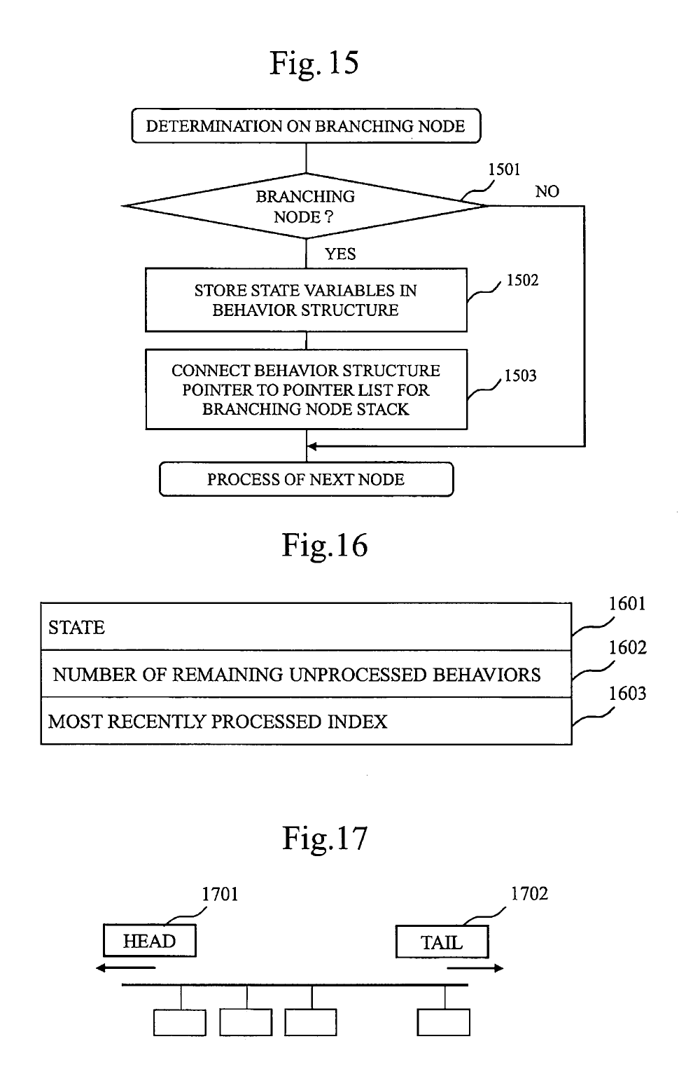

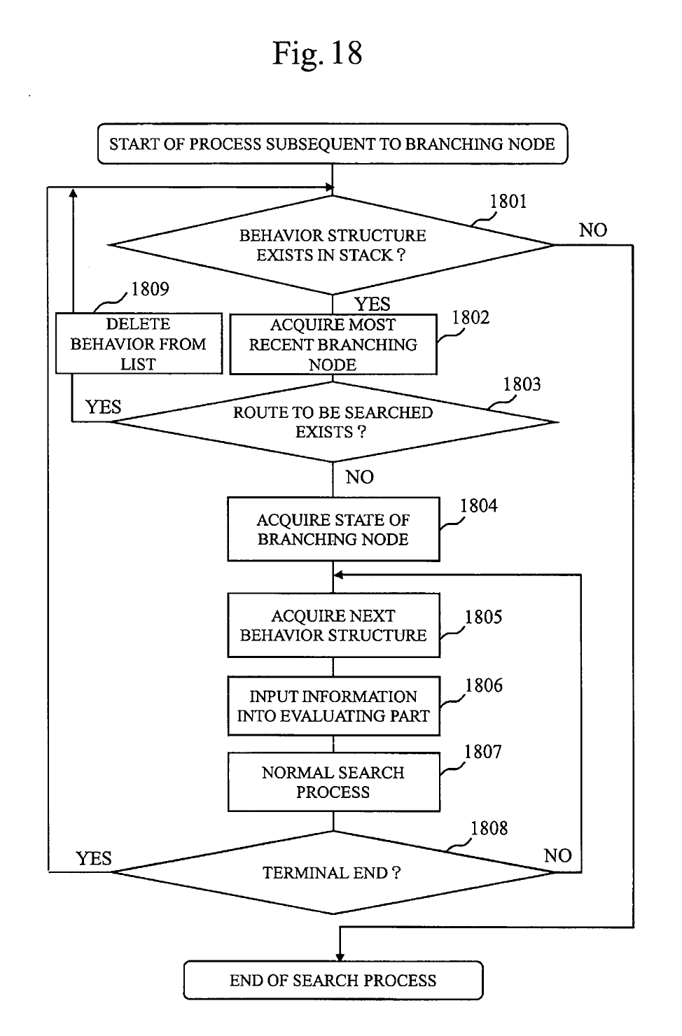

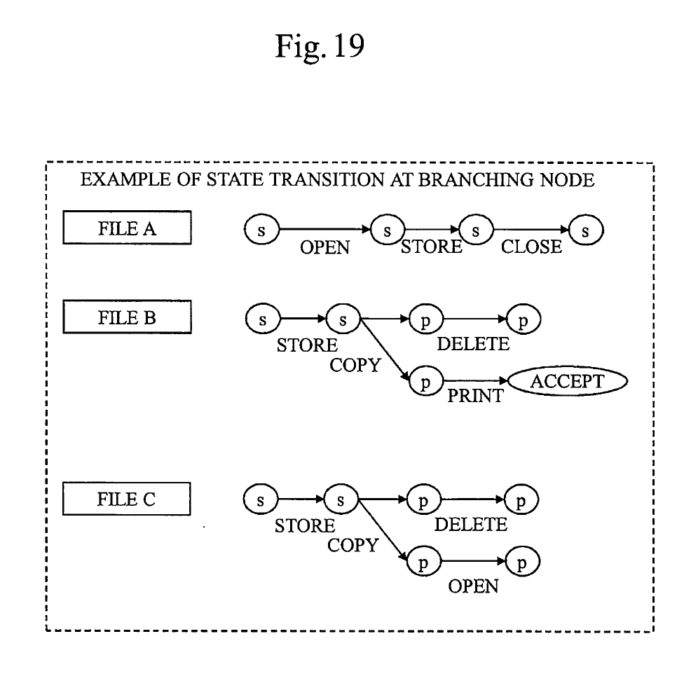

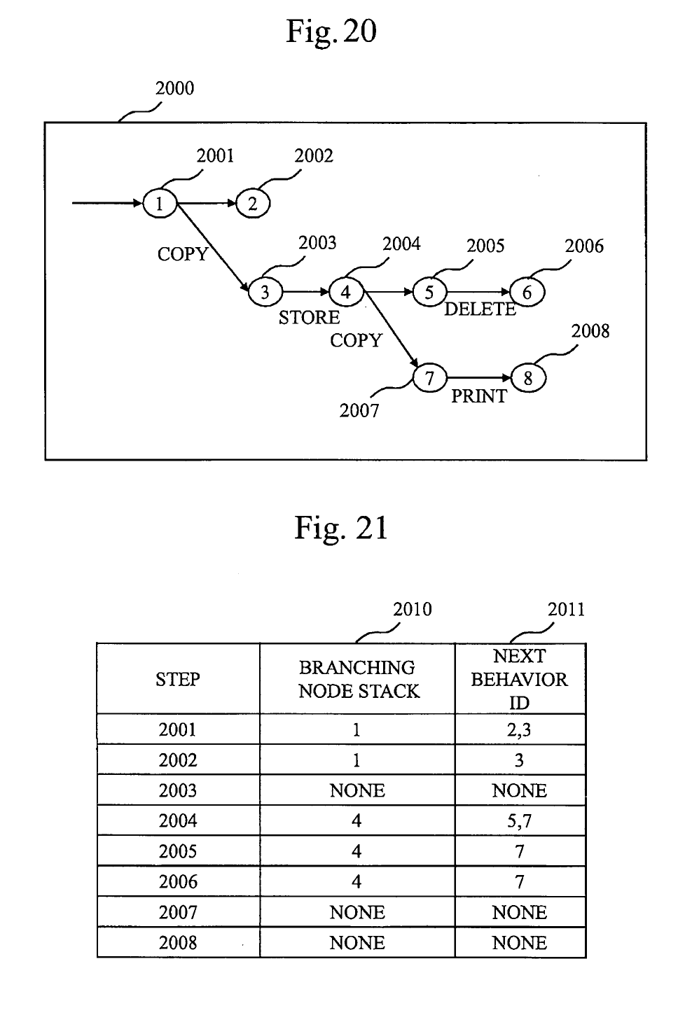

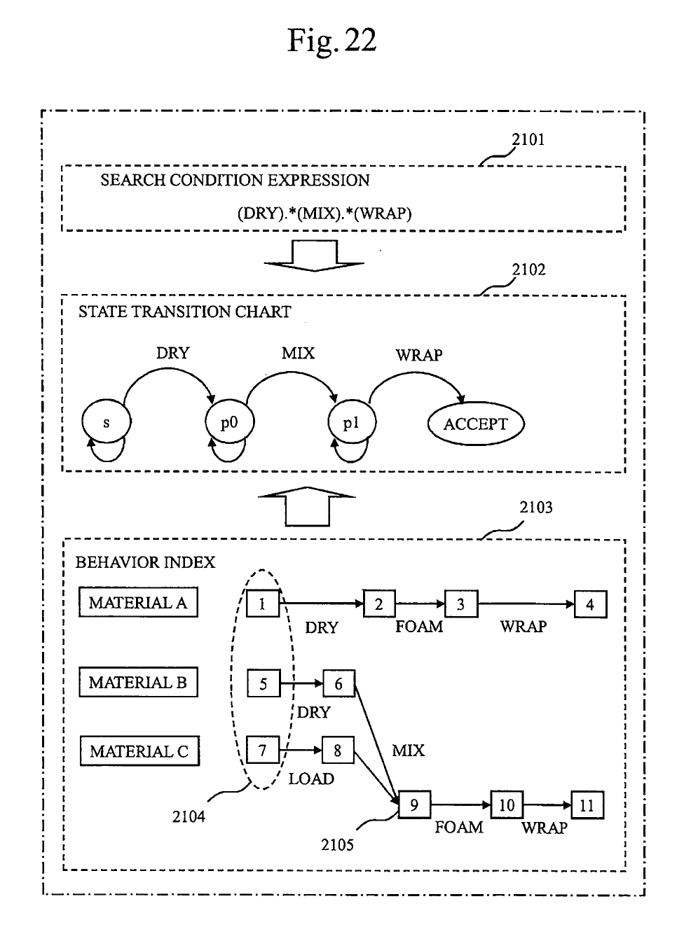

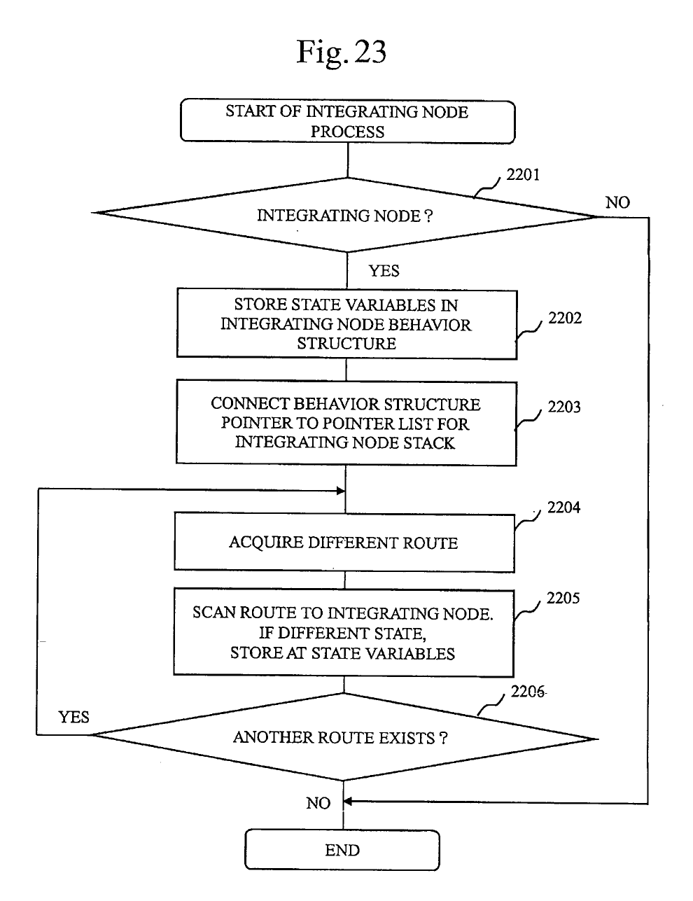

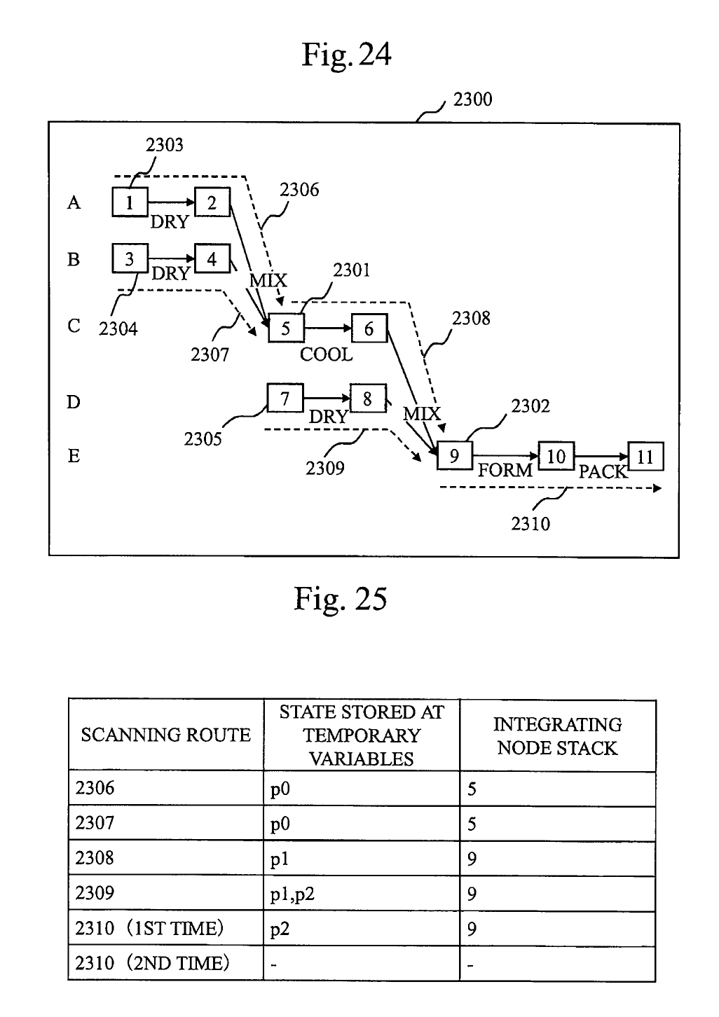

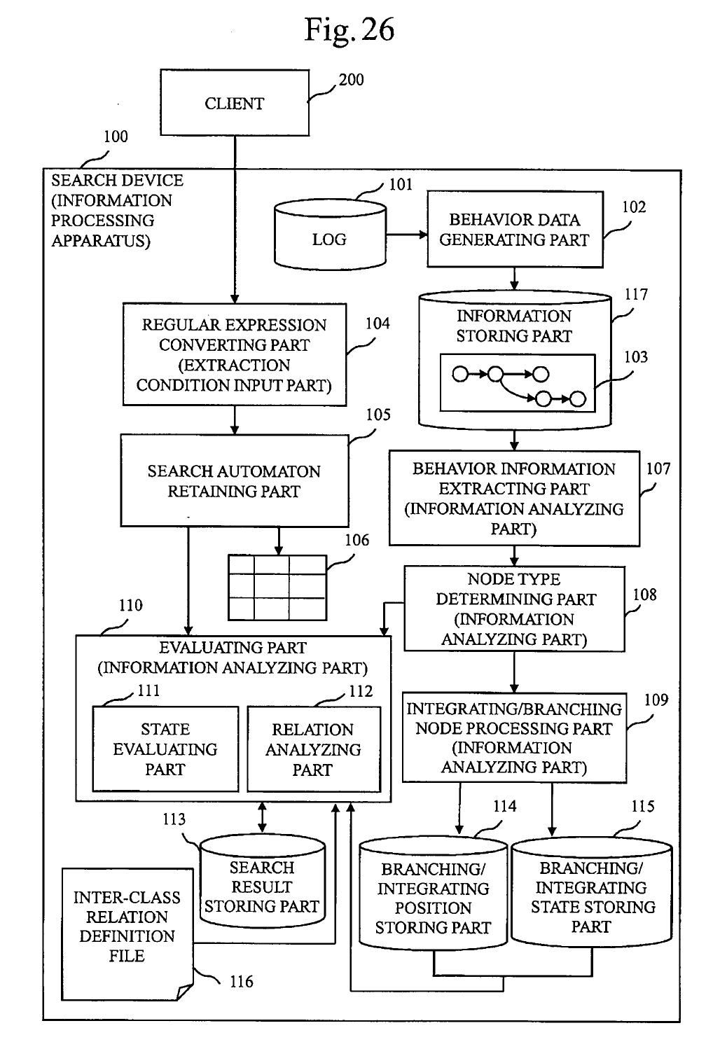

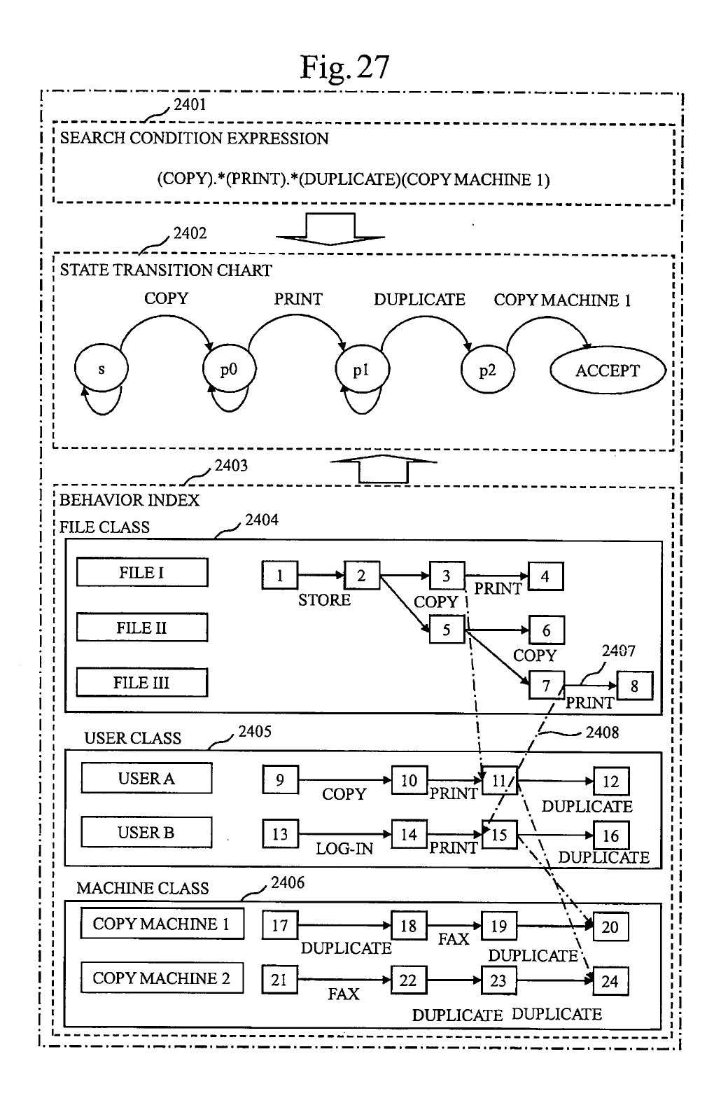

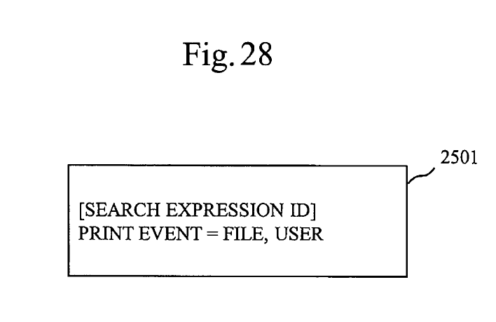

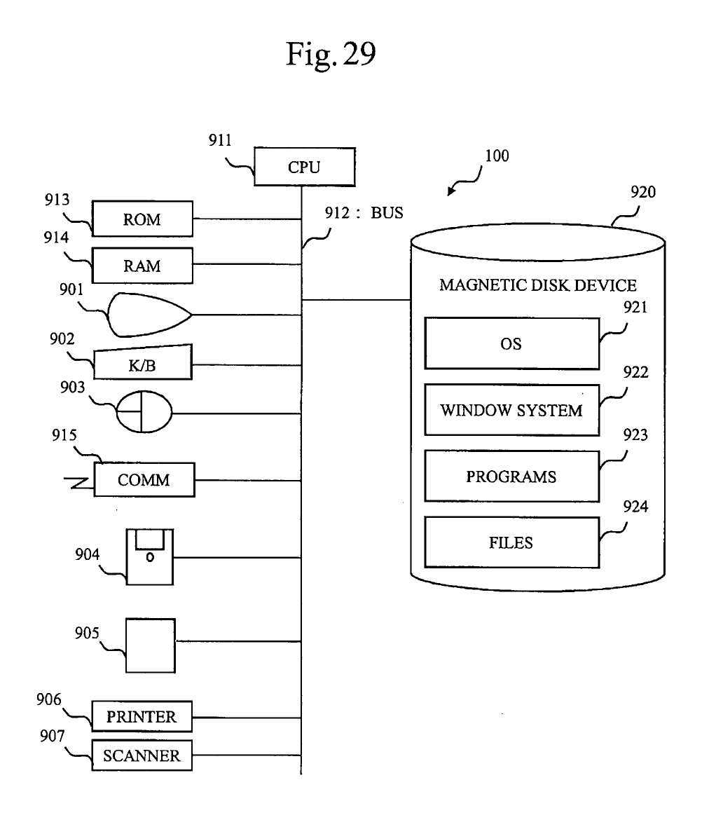

### REFERENCE SIGNS LIST

100 search device, 101 log, 102 behavior data generating part, 103 behavior index, 104 regular expression converting part, 105 search automaton retaining part, 106 state transition table, 107 behavior information extracting part, 108 node type determining part, 109 integrating/branching node processing part, 110 evaluating part, 111 state evaluating part, 112 relation analyzing part, 113 search result storing part, 114 branching/integrating position storing part, 115 branching/integrating state storing part, 116 inter-class relation definition file, 117 information storing part, 200 client

1. An information processing apparatus comprising
an information storing part that stores event history information which represents a history of a development of event occurrence by a connection of a plurality of nodes and which includes at least either one of a branching node connecting to two or more subsequent nodes and an integrating node connected to two or more preceding nodes, and
an information analyzing part that analyzes respective nodes of the event history information in accordance with a node connection order, sequentially from a former node, to identify events represented by the respective nodes; determines whether or not an analysis-target node corresponds to one of a branching node and an integrating node; if the analysis-target node is the branching node, analyzes respective nodes included in each of branching routes branching from the branching node in accordance with the connection order to identify events represented by the respective nodes; if the analysis-target node is the integrating node, analyzes respective nodes included in each of upstream routes that merge into the integrating node in accordance with the connection order to identify events represented by the respective nodes; and extracts one or more patterns of event occurrence order from the event history information.

2. The information processing apparatus according to claim 1, further comprising
an extraction condition input part that inputs extraction-target events and an extraction condition which indicates an appearance order of the extraction-target events,
wherein the information analyzing part determines whether or not the pattern of event occurrence order extracted matches the appearance order of the extraction-target events indicated by the extraction condition.

3. The information processing apparatus according to claim 2,
wherein the information storing part stores a plurality of pieces of event history information, and
wherein the information analyzing part extracts a pattern of event occurrence order from each event history information, and extracts event history information including the pattern of event occurrence order that matches the appearance order of the extraction-target events indicated by the extraction condition.

4. The information processing apparatus according to claim 1,
wherein the information storing part stores a plurality of pieces of event history information which are classified in a plurality of categories; and further stores two or more related pieces of event history information belonging to different categories, which are associated with each other; and
wherein the information analyzing part analyzes respective nodes of event history information belonging to a specific category; if the event history information of the specific category under analysis is associated with event history information of a different category, extracts the event history information of the different category associated with the event history information of the specific category, and analyzes nodes of the event history information extracted of the different category; and extracts one or more patterns of event occurrence order based on a combination of nodes of two or more pieces of event history information belonging to two or more categories.

5. The information processing apparatus according to claim 4,
wherein the information storing part stores two or more related pieces of event history information belonging to the different categories, which are associated with each other in units of nodes, and
wherein the information analyzing part analyzes the respective nodes of the event history information belonging to the specific category, and if a node under analysis is associated with a node in the event history information of the different category, extracts the node associated with the node under analysis and analyzes the node extracted.

6. The information processing apparatus according to claim 4,
wherein, if the event history information extracted of the different category is associated with event history information of a further different category, the information analyzing part extracts event history information of the further different category, analyzes nodes of the event history information extracted of the further different category, and extracts one or more patterns of event occurrence order based on a combination of nodes of three or more pieces of event history information belonging to three or more categories.

7. The information processing apparatus according to claim 6,
wherein the information storing part stores two or more related pieces of event history information belonging to different categories, which are associated with each other in units of nodes, and
wherein the information analyzing part analyzes nodes of the event history information extracted of the different category, and if a node under analysis is associated with a node in the event history information of the further different category, extracts the node associated with the node under analysis and analyzes the node extracted.

8. The information processing apparatus according to claim 1,
wherein, if the event history information includes the branching node, the information analyzing part selects an analysis-target branching route from among unanalyzed branching routes, analyzes respective nodes included in the branching route selected, in accordance with a connection order, sequentially from a former node, and after analysis of the respective nodes included in the branching route selected is ended, selects a new analysis-target branching route.

9. The information processing apparatus according to claim 1,
wherein, if the event history information includes the integrating node, the information analyzing part selects an analysis-target upstream route from among unanalyzed upstream routes, analyzes respective nodes included in the upstream route selected, in accordance with a connection order, sequentially from a former node, and after analysis of the respective nodes included in the upstream route selected is ended, selects a new analysis-target upstream route.

10. The information processing apparatus according to claim 9,
wherein, after analysis of all of the upstream routes of the integrating node is ended, the information analyzing part starts analysis of respective nodes that are subsequent to the integrating node.

11. The information processing apparatus according to claim 10,
wherein, as a result of analysis of all of the upstream routes of the integrating node, if it is discovered that the integrating node represents a plurality of types of events, the information analyzing part repeats analysis of the respective nodes that are subsequent to the integrating node for the number of types of events represented by the integrating node.

12. An information processing method comprising
with a computer, acquiring event history information which represents a history of a development of event occurrence by a connection of a plurality of nodes and which includes at least either one of a branching node connecting to two or more subsequent nodes and an integrating node connected to two or more preceding nodes, from a predetermined storage device, and
with the computer, analyzing respective nodes of the event history information in accordance with a node connection order, sequentially from a former node, to identify events represented by the respective nodes; determining whether or not an analysis-target node corresponds to one of a branching node and an integrating node; if the analysis-target node is the branching node, analyzing respective nodes included in each of branching routes branching from the branching node in accordance with the connection order to identify events represented by the respective nodes; if the analysis-target node is the integrating node, analyzing respective nodes included in each of upstream routes that merge into the integrating node in accordance with the connection order to identify events represented by the respective nodes; and extracting one or more patterns of event occurrence order from the event history information.

13. A program that causes a computer to execute
an information acquiring process of acquiring event history information which represents a history of a development of event occurrence by a connection of a plurality of nodes and which includes at least either one of a branching node connecting to two or more subsequent nodes and an integrating node connected to two or more preceding nodes, from a predetermined storage device, and
an information analyzing process of analyzing respective nodes of the event history information in accordance with a node connection order, sequentially from a former node, to identify events represented by the respective nodes; determining whether or not an analysis-target node corresponds to one of a branching node and an integrating node; if the analysis-target node is the branching node, analyzing respective nodes included in each of branching routes branching from the branching node in accordance with the connection order to identify events represented by the respective nodes; if the analysis-target node is the integrating node, analyzing respective nodes included in each of upstream routes that merge into the integrating node in accordance with the connection order to identify events represented by the respective nodes; and extracting one or more patterns of event occurrence order from the event history information.
